(19) United States
(12) Patent Application Publication
(10) Pub. No.: US 2024/0010302 A1
(43) Pub. Date: Jan. 11, 2024

(54) COMPRESSIVE ELEMENT FOR A MOORING COMPONENT

(71) Applicant: TFI MARINE LIMITED, BLACKROCK, DUBLIN (IE)

(72) Inventors: Paul McEvoy, Dun Laoghaire, Co Dublin (IE); Conor Casey, Dun Laoghaire, Co Dublin (IE); Osayomwanbor Ehiegharevba, Dun Laoghaire, Co Dublin (IE); Reinaldo Pereira, Dun Laoghaire, Co Dublin (IE)

(21) Appl. No.: 18/254,493

(22) PCT Filed: Nov. 25, 2021
(86) PCT No.: PCT/EP2021/083036

§ 371 Date: May 25, 2023

(30) Foreign Application Priority Data
Nov. 26, 2020 (GB) 2018636.7

(51) Int. Cl. B63B 21/20

(52) U.S. Cl. CPC B63B 21/20; B63B 2021/203

(57) ABSTRACT

A compressive element for a mooring component includes multiple shells. Each shell has first and second annular portions, and a central section that extends between the first and second annular portions. The first and second annular portions lie in a plane that is perpendicular to a central axis of the compressive element. The first annular portion has a maximum dimension in a direction perpendicular to the central axis that is greater than a corresponding maximum dimension of the second annular portion. The shells are arranged along the central axis such that the first or second annular portion of one shell is joined to the first or second annular portion of an adjacent shell. The compressive element is arranged such that when a compressive stress causes the compressive element to be compressed, the central section of one shell contacts the central section of an adjacent shell.

The present invention relates to a compressive element for a mooring component, in particular for a mooring component for mooring a floating structure in a body of water.

Floating marine structures, such as floating offshore wind turbines, may use a mooring system connected between the seabed and the floating marine structure to keep the structure in place. Typically such a mooring system will be designed so that any motion of the floating structure away from its desired position is resisted, and a restoring force is generated, to return the structure to the desired position. The desired position may also include a desired orientation, with the mooring element designed to resist any or all of surge, heave, sway pitch roll, and or yaw motions.

A range of different mooring system types exists, such as catenary, taut and semi-taut. All of these can use a range of mooring components such as chains, synthetic ropes, clump weights, anchors and floats. In shallower water, catenary chain systems are common.

However, these mooring systems are not particularly suitable for the mooring of certain floating marine structures, including floating offshore wind turbines or tidal turbines, in which the mooring lines experience a high average background thrust load due to the operation of the turbine, in addition to the dynamic loads (i.e. the force experienced by the mooring system before dynamic loads are applied, such as that which is applied by the mean wind or current).

With a background thrust, the structure will move to a new position (away from the direction of the background thrust) until the restoring force of the mooring system (i.e. the restoring force which returns a structure to its desired position and increases the further it moves from that position) matches the background thrust. A high background thrust therefore results in a high restoring force from the mooring system.

Under these conditions the stiffness of the mooring system (i.e. the force required to move the floating structure any further) is typically very high, as most mooring systems become progressively stiffer the further the floating structure moves from the desired location. When dynamic forces (i.e. waves) move the floating structure around its new position, this therefore results in very high variable loads (i.e. changes in tension) on the mooring system, requiring larger and more expensive mooring components (to protect against failure).

One approach to the problem is to try to modify the stiffness response of a mooring line by introducing new materials, such as disclosed in WO 2012/127015. These systems may work well when high background thrusts are not present. As discussed in WO 2012/127015, typical catenary chain mooring systems show undesirable stress-strain behaviour in high sea states, owing to the heavy weight of the catenary chains that must be used in order to provide the desired range of movement. Such large chains exert a large load on the floating structure, which subjects the chains, and the components connecting them to a floating structure, to high fatigue levels, thus risking failure of the chains.

WO 2012/127015 discloses an alternative mooring system comprising at least one tensile element and at least one compressive element as a proposed solution to overcome the problems encountered with catenary chains.

The Applicant has observed that sea depths in the range of 50 m to 100 m, where it is not uncommon to experience waves of up to 20 m, present a particular challenge for the mooring of floating marine structures. The angle of the mooring line between the platform and the seabed is important as it determines what fraction of the restoring force is applied to keeping the platform in position (force resisting surge=tension in mooring line*sine of angle between mooring line and platform). In a shallower environment a much longer length of chain needs to be lifted off the seabed to provide the restoring force than in deeper water, as the wave height and surge is a higher proportion of the water depth.

In a fibre rope mooring system the angle is again important as the fibre rope needs to be protected from striking the seabed while having enough length to allow for the required motion of the platform. This can be challenging in shallow environments, where the line length required can often be multiples of the water depth. Such relatively large waves (with respect to the sea depth) exert a high thrust on a floating marine structure, especially if the mooring system is already stiff owing to a high background load. For a floating offshore wind turbine (FOWT) where the background thrust owing to the turbine can easily exceed 100 tonnes and the mooring system may be very stiff, high wave conditions have the potential to drive mooring system forces beyond 1,000 tonnes. These huge forces require very expensive mooring components and very expensive specialist installation vessels to protect against failure.

The present invention aims to provide an improved compressive element for a mooring component which may be suited to high background thrust environments.

When viewed from a first aspect the invention provides a compressive element for a mooring component, the compressive element comprising a plurality of shells (i.e. at least two), wherein each of the plurality of shells comprises a first annular portion, a second annular portion and a central section;
wherein the first annular portion and the second annular portion each lie in a plane that is substantially perpendicular to a central axis of the compressive element, wherein the first annular portion has a maximum dimension in a direction substantially perpendicular to the central axis that is greater than a maximum dimension of the second annular portion in a direction substantially perpendicular to the central axis, and wherein the central section connects and extends between the first annular portion and the second annular portion;
wherein the plurality of shells are arranged along the central axis such that the first annular portion of one of the plurality of shells is joined to the first annular portion of an adjacent shell of the plurality of shells or such that the second annular portion of one of the plurality of shells is joined to the second annular portion of an adjacent shell of the plurality of shells;
wherein the compressive element is arranged such that when a compressive stress is applied to the compressive element substantially in the direction of the central axis, the compressive element is compressed; and
wherein the compressive element is arranged such that when the compressive stress applied to the compressive element causes the compressive element to be compressed by a particular fraction of an uncompressed length of the compressive element, the central section of one of the plurality of shells contacts the central section of an adjacent shell of the plurality of shells.

The present invention provides a compressive element for inclusion as part of a mooring component, e.g. in a mooring line or system, for mooring a floating structure such as a floating offshore wind turbine.

Each of the shells has first and second annular portions which are joined together by a central section. The first and second annular portions each lie in a plane which is substantially perpendicular to the central axis and are thus are positioned substantially parallel to each other, e.g. about a central axis (e.g. which extends through the centre of each of the first and second annular portions).

Preferably the first and second annular portions are arranged at the two (axial) ends of each shell of the compressive element (with respect to the central axis). The first and second annular portions are different sizes, with the first annular portion having, in a direction that is substantially perpendicular to the central axis of the compressive element, a maximum dimension (e.g. diameter) that is greater than the corresponding dimension of the second annular portion.

The compressive element is formed from a plurality of the shells joined together along the central axis by their respective first or second annular portions. It will be understood that the term “joined” encompasses these shells having been manufactured separately and subsequently joined together, but also that a number of shells may be integrally formed as a single unit, and thus as a result of having been formed integrally, adjacent shells will be joined together. For example, two adjacent shells, e.g. forming an hour-glass shape, may be formed integrally together e.g. moulded, then possibly subsequently joined to other shells to form a larger compressive element. It will likewise be understood that the distinction between the first annular portion, second annular portion and central section may be merely conceptual, since each shell may be formed integrally.

Adjacent shells may be connected by their respective first annular portions or by their respective second annular portions. However, as will be discussed, when the compressive element comprises three or more shells (as will be the case in some embodiments), both the first and second annular portions of at least one of the shells may be joined to the respective first and second annular portions of others of the shells. The adjacent shells may be joined in any suitable manner, e.g. they may be glued or welded together.

The central section of each shell optionally comprises a (first) shoulder portion that projects from the central section, e.g. either from the internal surface of the shell towards the central axis or from the external surface of the central section away from the central axis. The shoulder portion of the central section may be arranged such that when two shells, joined at their respective first or second annular portions, are compressed along the central axis by a compressive stress applied to the compressive element substantially in the direction of the central axis, the respective (first) shoulder portions of the two shells contact each other when the compression of the compressive element reaches a particular fraction of its uncompressed length, i.e. it is particularly the shoulder portions of the central sections which contact each other. The uncompressed length is the length of the compressive element in its fully uncompressed state when no compressive stress is applied to the compressive element (i.e. corresponding to the zero strain point in the compressive element's stress-strain response curve).

It will be understood by the skilled person that, since the central section connects the first annular portion and the second annular portion, and since the maximum dimension of the first annular portion is greater than that of the second annular portion (e.g. the first annular portion has a larger radius than the second annular portion) the central section, on average and at at least some point along its length, is angled between them, with respect to the central axis. This results in the central section dividing the compressive stress, applied in the direction of the central axis, into components of the stress that are parallel with and perpendicular to the central axis.

The parallel component of this stress will result in a deformation of the central section, based on its mechanical properties. The perpendicular component of the stress will be resisted by hoop stress in the first and second annular portions, e.g. since any deformation in this direction would increase the diameter of the first annular portion and decrease the diameter of the second annular portion.

The angle between the central axis and the direction between the first and second annular portions (e.g. along the average path of the central section), along which the compression stress acts through the contact points between adjacent shells (owing to where they join together at the respective first or second annular portions), can be seen as a “load pathway”.

The angle of this load pathway determines how much of the compression stress acts perpendicularly to the central axis on the annular portions and how much acts parallel with the central axis through the central section.

As the angle of the load pathway changes, owing to the compression of the compressive element and thus the shells, the perpendicular component of the stress will change, resulting in a modified compression behaviour. This angle changes gradually, under the compression stress as the compressive element is compressed, but encounters a step change when the compressive element is compressed by a particular fraction of its uncompressed length, owing to the central sections (optionally the shoulder portions) of adjacent shells coming into contact with each other.

The compressive element, with its plurality of shells, is arranged such that when a compressive stress is applied thereto along the direction of the central axis, the stiffness response (the gradient of the stress-strain response curve) which is produced depends on the compression of the compressive element. In particular, the response depends on the particular fraction of the uncompressed length to which the compressive element is compressed such that the central sections of one shell contacts the central section of an adjacent shell. It will be seen the contacting of the respective central section (e.g. shoulder portions) changes the angle of the load pathway, and thus alters the stiffness response of the compressive element, e.g. by providing a resistance against further compression of the compressive element.

Thus it will be seen that, in accordance with the invention, by forming the shells with a first annular portion, a second annular portion and a central section connected between them (and optionally comprising a shoulder portion), a compressive element is produced in which a particular compression can be chosen at which the stiffness behaviour of the compressive element changes. This helps the compressive element, at low thrust (compressive stress) values to provide a high stiffness response, e.g. owing to the relatively small angle between the load pathway and the central axis, so that the compressive element deforms by only a small fraction of its maximum deformation.

When, as is preferred, the compressive element forms part of a mooring component that extends under tensile stress owing to compression of the compressive element, this extends the mooring component (and thus, for example, the mooring line or system of which it forms a part) by only a small amount. This is desirable so that at higher thrust levels the compressive element may be able to provide a larger amount of deformation, such that it may be able to provide continuous elongation of a mooring line (e.g. comprising the compressive element).

The arrangement of the annular portions and the central section also help to provide a lower stiffness at a higher thrust, e.g. owing to the increasing angle between the load pathway and the central axis.

The behaviour of the compressive element (and thus a mooring component in which it is used) of the present invention contrasts, for example, with the mooring system disclosed in WO 2012/127015 and other conventional mooring systems, in which the mooring component allows a mooring line to stretch almost to its maximum length under any high background thrust experienced by the mooring line. At this high extension, the mooring line is very stiff and small increases in extension, for example due to wave motion, now result in large increases in tension.

Therefore such conventional mooring lines provide a less desirable stress-strain response in higher sea states, where high background thrust might exist (e.g. floating wind platforms, floating tidal turbine platforms, environments with high currents). The compressive element of the present invention, for use in a mooring component suitable for use in marine floating structure mooring lines, provides a more desirable stress-strain response, as the compression of the compressive element at which the stiffness softens and then the central sections of adjacent shells contact, may be chosen to match a background thrust. This helps to allow motion beyond this point to experience the lower stiffness behaviour which occurs above this compression.

The compressive element may be arranged (e.g. as a result of the central sections/shoulder portions contacting each other) to provide any suitable and desired stress-strain response to a compressive stress being applied thereto. In one embodiment, the compressive element is arranged such that the compressive stress applied to the compressive element up to a first stress value of the compressive stress compresses the compressive element in a first stage of compression by up a first fraction of an uncompressed length of the compressive element. The first fraction of the uncompressed length of the compressive element is preferably less than the particular fraction of the uncompressed length of the compressive element at which the central sections of adjacent shells are arranged to contact each other.

In this first stage of compression, the compressive element undergoes (e.g. elastic) compression when a compressive stress up to a first stress value is applied to the compressive element. Exposed to this first stress value, the compressive element is compressed by the first fraction of its uncompressed length (i.e. the compressive element has its length reduced by the first fraction of its uncompressed length). Preferably the compressive element has an average stiffness having a first stiffness value in the first stage of compression.

The first fraction of the uncompressed length may be any suitable and desired value by which the compressive element is compressed during the first stage of compression. In one embodiment the first fraction is between 10% and 20%, e.g. approximately 15%, of the uncompressed length. Thus, when the compressive element experiences a compressive stress equal to the first stress value, preferably the compressive element is compressed to a resultant length that is between 80% and 90%, e.g. approximately 85%, of its uncompressed length.

Optionally the compression of the compressive element is approximately (e.g. directly) proportional to the compressive stress experienced by the compressive element up to the first value of the compressive stress, i.e. preferably the stress-strain curve of the compressive element is approximately linear in the first stage of compression. Preferably the gradient of the stress-strain curve of the compressive element is positive for all values of the compressive stress up to the first stress value.

The first value of the compressive stress may be chosen in any suitable and desired way, e.g. depending on the intended use for the compressive element. Preferably the compressive element is arranged (e.g. manufactured) such that the first value of the compressive stress is slightly below the compressive stress expected to be experienced by the compressive element (when forming part of a mooring component) in benign conditions (i.e. low operational wind thrust with low waves and current). The first value of the tensile stress is therefore the lowest load that a mooring system using the compressive element component is expected to have to operate at, taking into account the dynamic loads around the average thrust in benign conditions. The first stress value may be a significant fraction of the average thrust, e.g. at least 70%, optionally at least 80%, further optionally at least 90%.

The first value of the compressive stress may be determined, as appropriate (and, e.g., the compressive element manufactured and assembled accordingly), for the particular conditions (e.g. location) that the compressive element is expected to experience, e.g. when installed in a mooring system for a floating structure. For example, for a floating offshore wind turbine the background thrust may be determined from the size of the turbine, the operational wind conditions, the number and alignment of mooring lines, the platform behaviour, and benign environmental conditions. Thus, different compressive elements for different applications (e.g. floating structures and/or environments) may be designed differently to provide them with a different value for the first value of the compressive stress.

The compressive element may be configured in any suitable and desired way to provide any suitable and desired response in the first stage of compression. Preferably the compressive element is arranged such that the applied compressive stress acts on the compressive element substantially to compress the length of the central section of the compressive element.

Thus, preferably the compressive element is arranged such that the annular portions of the compressive element have a hoop stress that substantially resists the component of the compressive stress acting in tension on the first annular portion (e.g. the component of the compressive stress that is trying to stretch the diameter) and in compression on the second annular portion (trying to shrink the diameter). It will be understood that the relatively high stiffness behaviour in the first stage of compression results in a relatively large change in the applied compressive stress being required to generate a relatively small change in the length of the compressive element.

Thus, the stiffness behaviour of the compressive element may depend on the compression response of the central section in a direction parallel to the central axis. In the first stage of compression, the central section may have a relatively high stiffness, so that for a given compression stress, the central section deforms in the direction parallel to the central axis relatively little, e.g. the buckling forces on the central section are substantially resisted by its strength, resulting in relatively few changes to its shape. The central section may also resist flexing of the central section (e.g. a change in angle between the first and second annular portions), owing to the first and second annular portions resisting deformation (e.g. expansion or contraction), and therefore the angle of the central section (and the load pathway) to the central axis changes relatively little.

The stiffness behaviour of the compressive element may depend on the response of the annular portions, e.g. on the hoop stress of the first and second annular portions. The annular portions may be arranged in any suitable and desired way to provide this response. Preferably the annular portions are defined as (and thus comprise) portions of the (e.g. shells of the) compressive element over which the internal and/or external surfaces of the (e.g. shells of the) compressive element are substantially parallel to the central axis of the compressive element. Preferably the annular portions define the extremities of (e.g. each of) the shells (in the direction along the central axis) of the compressive element.

In one embodiment the thickness of the first and/or second annular portions (e.g. in a radial direction, perpendicular to the central axis) is greater than a minimum thickness (e.g. in an outward direction from the central axis, along which the distance between the inner and outer surfaces of the central section is a minimum) of the central section (e.g. the thickness of the central section adjacent to the first and/or second annular portion respectively).

The first and second annular portions may have any suitable and desired height (in a direction parallel to the central axis). The first and/or second annular portions may have a height which is almost zero, e.g. there may be substantially no distance along the central axis between central sections of adjacent shells. Preferably the length of the central section (between the first and second annular portions, e.g. in a direction along the load pathway, e.g. when the compressive element is uncompressed) is greater than the height (and, e.g., the thickness) of the first and/or second annular portions. Preferably the thickness of the first and/or second annular portions is greater than a height of the first and/or second annular portions respectively.

Preferably, the difference in size between the first annular portion and the second annular portion is sufficiently large to allow the compressive element to be compressed to a resultant length which is less than half of its uncompressed length. Preferably the maximum dimension (e.g. diameter) of the first annular portion is greater than 40% (e.g. greater than 50%) larger than the maximum dimension (e.g. diameter) of the second annular portion. This helps to provide suitable space for the central sections of the compressive element to be flexed and compressed between the respective first and second annular portions, such that it allows the compressive element to be compressed to a resultant length which is less than half of its uncompressed length.

In one embodiment, the compressive element is arranged such that the compressive stress applied to the compressive element above a first stress value of the compressive stress and up to a second stress value of the compressive stress further compresses the compressive element in a second stage of compression by greater than the first fraction of the uncompressed length of the compressive element and up to a second fraction of the uncompressed length of the compressive element. The second fraction of the uncompressed length of the compressive element is optionally greater than the particular fraction of the uncompressed length of the compressive element at which the central sections or (first) shoulder portions of adjacent shells are arranged to contact each other, i.e. the compressive element may be arranged such that the central sections or shoulder portions of adjacent shells contact each other during the second stage of compression of the compressive element. During the second stage of compression, the compressive element exhibits an average stiffness having a second stiffness value, wherein the first stiffness value (in the first stage of compression) is preferably greater than the second stiffness value. In some embodiments, additionally or alternatively, adjacent shells may be arranged to contact each other during the second stage, e.g. at a contact point which is not the (first) shoulder.

The compressive element, in the second stage of compression (i.e. the response of a second section of its stress-strain curve, at higher compressive stresses than the first value of the compressive stress), undergoes compression when a compressive stress above the first stress value and up to a second stress value is applied to the compressive element. Exposed to this second stress value, the compressive element is compressed by the second fraction of its uncompressed length (i.e. the compressive element has its length reduced by the second fraction of its uncompressed length).

The second fraction of the uncompressed length may be any suitable and desired value (including the first fraction) by which the compressive element is compressed by during the second stage of compression, when the compressive element has an average stiffness having a second stiffness value. In one embodiment the second fraction is between 40% and 50%, e.g. approximately 45%, of the uncompressed length.

Thus, when the compressive element experiences a compressive stress equal to the second stress value, preferably the compressive element is compressed to a resultant length that is between 40% and 60%, e.g. approximately 50%, of its uncompressed length. Furthermore, for compressive stresses that are experienced in the second stage of compression (i.e. compressive stresses between the first and second stress values), preferably the compressive element is compressed from 80% to 90% (e.g. approximately 85%), at the first stress value, to 40% and 60% (e.g. approximately 50%), at the second stress value, of its uncompressed length. Thus during the second stage of compression the compressive element may be compressed across a compression distance which is at least twice as long as the distance over which compression occurs in the first (or pre-tension) stage, optionally at least 3 times as long. The second fraction of the uncompressed length may be between approximately 20-50% of the uncompressed length. The distance through which the compressive element(s) is compressed during the second stage, i.e. the distance between the first fraction and the second fraction, is greater than the distance of the first fraction, and may, additionally or alternatively, be greater than a total compression distance in the third (survival) stage. Thus the majority of the change of length of the compressive element(s) during compression occurs during the second (operational) stage. It will be appreciated that preferably the amount of compression in the second stage is greater than the amount of compression in the first stage.

Preferably the compression of the compressive element is approximately (e.g. indirectly) proportional to the compressive stress experienced by the compressive element between the first and second stress values of the compressive stress, i.e. preferably the stress-strain curve of the compressive element is approximately linear in the second stage of compression (but having a gradient that is less than the gradient of the stress-strain curve in the first stage of compression). Preferably the gradient of the stress-strain curve of the compressive element is positive for all stress values of the compressive stress between the first and second stress values.

Thus, preferably the gradient of the stress-strain curve of the compressive element is positive for all stress values of the compressive stress up to the second value. This helps to prevent the compressive element from getting trapped at a particular compression (which may happen, e.g. if there were to be a negative gradient in the stress-strain curve, or due to small variations in manufacture).

The second value of the compressive stress may be chosen in any suitable and desired way, e.g. depending on the intended use for the compressive element and the mooring component.

Preferably the compressive element is arranged (e.g. manufactured) such that the second value of the compressive stress is approximately equal to the compressive stress expected to be experienced by the compressive element under the Ultimate Limit State (the highest unfactored load expected to be experienced by the component). This limit state may occur under a peak state during operation of a turbine (i.e. maximum thrust in a turbine-operational environmental condition), a survival sea state (i.e. maximum wave and wind loading but no thrust from an operating turbine), or an accidental limit state (i.e. highest load experienced when an unexpected condition occurs such as a mooring line breaking).

The second value of the compressive stress may be determined, as appropriate (and, e.g., the compressive element manufactured and assembled accordingly), for the particular conditions (e.g. location) that the mooring component is expected to experience, e.g. when installed in a mooring system for a floating structure. For example, for a floating offshore wind turbine the peak thrust may be determined from the peak thrust expected from the wind and/or wave conditions during a once in 50 years storm. Thus, different compressive elements for different applications (e.g. floating structures and/or environments) may be designed differently to provide them with a different value for the second value of the compressive stress.

As outlined above, in some embodiments the central sections or (first) shoulder portions of adjacent shells of the compressive element are arranged to contact each other in the second stage of compression, e.g. the particular fraction of the uncompressed length at which the central sections/shoulder portions are arranged to contact each other is between the first and second fractions of the uncompressed length of the compressive element. However, the particular fraction may take any suitable and desired value.

The particular fraction may be selected such that a desired stress-strain response may be achieved, owing to this being the fraction of the uncompressed length at which the angle of the load pathway experiences a step change. The particular fraction may also be the fraction of the uncompressed length at which the compressive element begins to deform significantly under compression. As explained above, the contacting of the central sections, e.g. shoulder portions, of adjacent shells and the changing of the angle of the load pathway helps to prevent the gradient of the stress-strain curve from turning negative.

It will be appreciated that the stiffness response of the compressive element, before and after the particular fraction of the uncompressed length at which the central sections contact each other, and indeed the value of the particular fraction itself, may be determined by a number of features and parameters of the compressive element, in addition to the optional shoulder portion as described above. For example, the compressive element may be arranged such that, in the second stage of compression, the compression (and thus the stiffness behaviour) of the compressive element is dominated by deformation of the central sections of the compressive element.

The behaviour of the compressive element in the second stage of compression may be controlled by arranging the compressive element such that one or more (e.g. all) of the maximum dimension (e.g. diameter) of the first annular portion increases, the maximum dimension (e.g. diameter) of the second annular portion decreases, and the central section deforms (e.g. bends). Since the portions of the compressive element are three-dimensional, complex shaping may also be used to achieve the desired result. For example, the second annular portion may be arranged to bend inwards as the compressive stress is increased to compress the compressive element by more than the particular fraction. This helps to shrink the diameter of the second annular portion and thus allows for further compression of the compressive element under further increases of the compressive stress.

In some embodiments, the central section is configured to deform (e.g. bend, as opposed to simply flexing relative to the first and second annular portions) when the compressive stress exceeds a threshold that causes the compressive element to be compressed by more than the particular fraction. This could be achieved by the first and second annular portions being arranged to be more resistant to deformation (e.g. stronger) than the central section, e.g. such that their resistance to hoop stress deformation is stronger than any resistance to hoop stress and/or buckling deformation in the central section. This may be achieved in any suitable and desired way.

In some embodiments, additionally or alternatively, the first annular portion and/or the second annular portion is configured to deform when the compressive force exceeds the threshold that causes the compressive element to be compressed by more than the particular fraction. For example, the first annular portion and/or the second annular portion may have a hoop stress which is overcome when the compressive element is compressed by greater than the particular fraction. It will be appreciated that this change may cause at least a portion of the central section to rotate, e.g. to flex towards a direction substantially perpendicular to the central axis.

Thus in such embodiments, the hoop stress of the annular portions may be exceeded and the annular portions may then deform under the applied compressive stress. This may result in a change in the stress-strain behaviour of the compressive element, allowing for a larger amount of compression of the compressive element for a relatively small increase in the applied compressive stress.

This control of the stress-strain behaviour of the compressive element may be achieved, in one embodiment, by using a softer or thinner material in the annular portions (owing to the change in diameter due to hoop stress being related to the applied stress, and the thickness, diameter and material strain of the annular portions), or by varying the (e.g. thickness of the) annular portion radially.

In some embodiments the central section has a non-uniform thickness along its length, i.e. the thickness perpendicular to the central axis varies along the central axis. In some embodiments, the central section has a non-uniform shape, such that a thickness of the central section parallel to the central axis varies along the central axis, e.g. the shape of the central section bends so that thickness along the horizontal plane changes.

Regardless of how the compression behaviour in the second stage is achieved, preferably the compressive element is arranged to maintain smooth deformation or bending behaviour (e.g. Euler buckling), throughout the compression of the compressive element, e.g. throughout the first, second and/or third stage of compression. This may be achieved, for example, by reducing or even avoiding any limit point instability in the design, an instability being a position at which the shell structure undergoes a large deformation into a different shape which is also stable.

Such instability could cause a negative stiffness at some point along the stress-strain response curve of the compressive element, allowing the applied compressive stress to snap between different shells, causing some shells to collapse while others relax back to their original lengths. Such behaviour creates high fatigue both on the compressive element and on a mooring system including such a compressive element, as loads constantly snap up and down.

The stress-strain response of the compressive element is preferably a (substantially) non-plastic response, i.e. the component is designed to repeatedly undergo compressions, for example up to the second stiffness value (i.e. during the first and second stages) with minimal loss of performance, such that the mooring component returns to substantially its original shape when an applied tensile stress is subsequently removed.

In one embodiment, the compressive element is arranged such that a compressive stress experienced by the compressive element above the second stress value of the compressive stress further compresses the compressive element in a third stage of compression by greater than the second fraction of the uncompressed length of the compressive element. During the third stage of compression the compressive element exhibits an average stiffness having a third stiffness value; wherein the third stiffness value is preferably greater than the second stiffness value (in the second stage of compression) and additionally or alternatively greater than first stiffness value (in the first stage of compression). Optionally the third stiffness value is at least 50% greater than the second stiffness value. This higher stiffness helps the compressive element to provide a sharp increase in tension as the compression distance of the compressive element is compressed past the second fraction.

Thus, in this embodiment, the response of the compressive element changes again, to having a response that is stiffer than in the second stage and optionally even stiffer than in the first stage, such that the at least one compressive element experiences very little compression in the third stage. A much higher increase in compressive stress on the compressive element is therefore required for any further compression.

Thus, in some embodiments, there is provided a compressive element in which the stiffness changes from initial high stiffness (in the first stage), to lower stiffness (in the second stage) and then back to high stiffness (in the third stage) owing to the deformation of the shells, as the compression of the compressive element increases.

This higher stiffness response at high compression, during the third stage of compression, helps to provide important safety features for the compressive element (and the mooring component of which it may form a part). It helps the compressive element to endure very high compressions, e.g. the ultimate limit state (ULS) of the mooring system, while reducing the risk of damage. Such a state may occur, for example, in the event that a floating marine structure is moored with multiple mooring lines, including a mooring component comprising the compressive element of the present invention, and one or more of the other mooring lines breaks.

The compressive element, in the third stage of compression (i.e. the response of a third section of its stress-strain curve, at higher compressive stresses than the second value of the compressive stress), undergoes compression when a compressive stress above the second stress value is applied to the compressive element. Exposed to this compressive stress of greater than the second stress value, the compressive element is compressed by greater than the second fraction of its uncompressed length (i.e. the compressive element has its length reduced by more than the second fraction of its uncompressed length).

As outlined above, preferably the second fraction of the uncompressed length is between 40% and 50%, e.g. approximately 45%, of the uncompressed length. Thus, the compressive element is compressed during the third stage of compression, when the compressive element has an average stiffness having a third stiffness value, by more than 40% or 50%, e.g. more than approximately 45%, of the uncompressed length.

Thus, when the compressive element experiences a compressive stress greater than the second stress value, preferably the compressive element is compressed to a resultant length that is at least 50% or 60%, e.g. at least approximately 55%, of its uncompressed length.

Preferably the compression of the compressive element is approximately (e.g. indirectly) proportional to the compressive stress experienced by the compressive element above the second stress value of the compressive stress, i.e. preferably the stress-strain curve of the compressive element is approximately linear in the third stage of compression (but having a gradient that is greater than the gradient of the stress-strain curve in both the first and second stages of compression). Preferably the gradient of the stress-strain curve of the compressive element is positive for all stress values of the compressive stress above the second stress value.

Thus, preferably the gradient of the stress-strain curve of the compressive element is positive for all stress values of the compressive stress up to and greater than the second value. This helps to prevent the compressive element from getting trapped at a particular compression (which may happen, e.g. if there were to be a negative gradient in the stress-strain curve, or due to small variations in manufacture).

The higher stiffness of the compressive element during the third stage of compression may be chosen in any suitable and desired way, e.g. depending on the intended use for the mooring component. Preferably the compressive element is arranged (e.g. manufactured) such that the stiffness of the compressive element during the third stage of compression substantially resists further compression of the compressive element. This helps to provide important safety features for the compressive element and associated mooring component. For example, it helps the compressive element to endure very high compressions. Preferably, the tension in the compressive element towards the end of the third stage of compression is equal to approximately 1.5-2 times greater than the ultimate limit state (ULS) of the mooring system.

In one embodiment the additional compression of the compressive element during the third stage of compression (further to the compression in the first and second stages) is less than 10%, e.g. less than 5%, of the uncompressed length of the compressive element. Overall (i.e. cumulatively over all of the stages of compression), preferably the compressive element is arranged to be compressed by greater than 40% of its uncompressed length, e.g. greater than 45% of its uncompressed length, e.g. greater than 50% of its uncompressed length.

In some embodiments, the third stage of compression of the compressive element occurs owing to contact of (e.g. central sections of the) adjacent shells of the compressive element, e.g. at the shoulder portions described above, or as a result of a different location to the (first) shoulder portions of adjacent shells contacting each other. Thus in some embodiments, the central sections, (first) shoulder portions (or another part) of adjacent shells of the compressive element are arranged to contact each other in the third stage of compression, e.g. the particular fraction of the uncompressed length at which the central sections or shoulder portions are arranged to contact each other is above the second fraction of the uncompressed length of the compressive element. Thus in some embodiments the second fraction of the uncompressed length of the compressive element is less than or approximately equal to the particular fraction of the uncompressed length of the compressive element at which the central sections or shoulder portions of adjacent shells are arranged to contact each other

This helps to increase the stiffness of the compressive element in the third stage of compression through two mechanisms.

First, these contact points transfer load directly, reducing further buckling of the central section.

Second, the load pathway through the compressive element is changed by the contacting of the adjacent shells, by reducing the angle (relative to the central axis) through which further compressive stress is applied to the compressive element and increasing the material area sharing that load.

Thus the adjacent shells of the compressive element may be arranged to contact each other during (e.g. at the beginning of) the third stage of compression in any suitable and desired way.

The first and/or second shoulder portions may be arranged in any suitable and desired way on the central portion. In one embodiment the first shoulder portion projects (in a direction) towards the first annular portion. Preferably the first shoulder portion has a thickness (e.g. through the shell) that is greater than the thickness of the central section adjacent to (e.g. either side of) the first shoulder portion.

In some embodiments the first shoulder portion is shaped so that, when the compressive stress applied to the compressive element causes the compressive element to be compressed by the particular fraction of the uncompressed length of the compressive element, the first shoulder portion (in this compressed configuration) projects further towards the adjacent shell (in a direction parallel to the central axis) than any other part of the central section (i.e. other than the (e.g. first) annular portion joining the adjacent shells). This helps the first shoulder portion to contact an adjacent shell before the central section would otherwise do.

To achieve this effect, the first shoulder portion need only project further (e.g. in the direction of the central axis) than the rest of the central section, at the stage of compression at which contact between the first shoulder portions occurs. Since the angle of the central section changes (relative to the central axis) during compression, the first shoulder portion therefore need only extend further in this direction at the stage of compression at which contact occurs, not necessarily when the compressive element is unstressed.

Each shell (and thus the compressive element) may be made out of any suitable and desired material. Any chosen material should have suitable fatigue properties to allow for the frequent changes in shape that will be applied by wave motion. Preferably the compressive element comprises a (thermo)polymer, e.g. an elastomer. The spring may be formed from one or more individual polymer materials with different mechanical properties, each material applied to a different part of the polymer spring such that the different parts of the spring react differently to the same applied stress. In one embodiment the first and/or second annular portions comprise a (e.g. elastomeric) material that is stiffer than the material of the central section. For example, the first and/or second annular portions may be made of a higher grade or stiffer polymer (e.g. elastomer) material.

In some embodiments the central section extends continuously in an azimuthal direction around the central axis. Preferably the central section comprises a cross sectional profile (in a plane that contains the central axis) rotated (e.g. through 360 degrees) about the central axis. This may enable the central section to be formed as a single (integral) piece, e.g. in a single stage, e.g. using a single mould.

In some embodiments the central section is formed separately from the first and second annular portions. The central section and the first and second annular portions may then be joined together to form the shell. This may, for example, allow the central section and the first and second annular portions to be formed from different materials. However, preferably the central section is formed integrally with the first and second annular portions. Again, this helps to allow the whole of the shell to be formed as a single (integral) piece, e.g. in a single stage, e.g. using a single mould.

In some embodiments the central section comprises a plurality of discrete sections each connected between the first annular portion and the second annular portion to form a shell.

Preferably each discrete section comprises a cross-sectional profile (in a plane that contains the central axis) rotated about the central axis by less than 180 degrees. This may enable the central section of the shell to be formed from less material, e.g. than may be needed to form the central section for a shell of the same size (e.g. overall maximum dimensions) when the central section is a cross-sectional profile rotated through 360 degrees. These smaller central sections may also be easier to manufacture, e.g. using smaller moulds. Thus it may be possible to manufacture the smaller central sections more cheaply, easily and quickly than one continuous central section.

Furthermore, the Applicant has appreciated, unexpectedly, that, in at least preferred embodiments, a shell comprising a plurality of discrete central sections may be able to provide a stress-strain response that is approximately equivalent to that of a shell with a 360 degree central section, while using less material. Preferably the discrete central sections each comprise a cross-sectional profile (i.e. a shaped profile), rotated through less than 90 degrees azimuthally about the central axis, e.g. through less than 45 degrees, e.g. through less than 20 degrees. Preferably the discrete central sections all have the same azimuthal extent, i.e. their cross-sectional profile is rotated through the same angle about the central axis. Preferably the cross-sectional profile of each of the discrete central sections is the same. Preferably the plurality of discrete central sections are equally spaced (e.g. azimuthally) from each other about the central axis.

In addition, or alternatively, to reducing the required material by constructing the shell from sections, the Applicant has further appreciated that material may be removed from certain parts of the shell profile, without substantially affecting the stiffness response of the shell. In particular, the Applicant has appreciated that the stiffness response of the shell may substantially be determined by the material which is present in the shell profile, but that the thickness of such a profile may be varied when rotated around the central axis. Such a profile could result in very thin or no material in some locations while still maintaining the desired overall stiffness profile.

The compressive elements described herein are suitable for incorporation within a mooring system. Thus according to a second aspect of the present invention there is provided a mooring system comprising a mooring line and a compressive element according to the first aspect of the present invention, wherein the compressive element is arranged between a first section of the mooring line and a second section of the mooring line such that tensile stress applied to the mooring line, which compresses the compressive element, causes the overall length of the mooring system to increase.

The invention also extends to a mooring component for a mooring line or system, wherein the mooring component comprises the compressive element according to the first aspect of the present invention, wherein the compressive element is arranged to undergo compression in response to a tensile stress experienced by the mooring component, wherein the compressive element is arranged such that compression of the compressive element induces an extension of the mooring component. The tensile stress experienced by the mooring component is converted into, and thus causes the compressive element to experience, the compressive stress.

The mooring component of the present invention may be a component of any suitable and desired mooring line or system, and for mooring any suitable and desired floating structure. The mooring system may comprise two or more of the mooring components connected, either connected at points along the same length of mooring line e.g. directly or indirectly connected to each other (i.e. in series) or there may be one or more mooring lines, each including more than one mooring component (i.e. in parallel).

In one set of embodiments the mooring component is submerged and is connected, directly or indirectly, between a floating structure and the seabed. For example, the mooring component may be connected between a floating structure, such as a floating fish farm, a floating platform (e.g. for a floating offshore wind turbine), and the seabed. The mooring system may comprise one or more mooring components, and a combination of different mooring components may be used. Typically, a mooring system comprises of multiple mooring lines wherein each of these lines may contain one or more mooring components according to an embodiment of the present invention. The number of mooring lines and/or mooring components may be chosen based on the extension required due to the maximum sea state. The mooring system may be a mooring system for a deep sea environment, a tidal flow environment or a shallow water environment.

Multiple mooring components connected along the same mooring line may be used to provide a desired extension of that mooring line, in order that the mooring line is able to accommodate a maximum wave height in a given mooring location. The number of components required to achieve a chosen extension length will depend on the length selected for each component.

In another set of embodiments, the mooring component is connected between two (or more) floating structures. The connection may be direct or indirect. Thus, in some embodiments, the component is connected, directly or indirectly, between a first floating structure and a second floating structure and optionally, the floating structures form part of an array. In such embodiments the mooring component can respond to movement of one floating structure by reacting against another floating structure that may have greater inertia.

In a set of preferred embodiments (e.g. when the mooring component is part of a mooring system), the mooring component is connected between a floating structure (e.g. platform) and the seabed. In at least some embodiments the mooring component is preferably connected between the floating structure and a mooring line that is connected to the seabed. The mooring line may comprise any combination of materials and mooring line components, including high modulus ropes (e.g. Dyneema®, wire rope), polymer ropes (e.g. polyester, nylon), chain, shackles, swivels, clump weights, or floats. The connection between the mooring component and the mooring line may be direct or indirect (e.g. via an attachment interface, as outlined below).

In one embodiment the mooring line comprises a catenary mooring chain. Such mooring systems may be used in shallow mooring systems, where mooring can be particularly challenging. It will be appreciated that embodiments of the present invention may be particularly suitable when used with such mooring lines.

A compressive element according to at least preferred embodiments of the present invention may be fitted into an existing mooring line. This may be achieved by removing a length of the mooring line of approximately the same length as the compressive element when experiencing a compressive stress approximately equal to the background load (e.g. the uncompressed length plus 10%), attaching a first end of the compressive element to a first section of the mooring line and attaching a second end of the compressive element to a second section of the mooring line.

Thus according to a third aspect of the present invention there is provided a method of altering an existing mooring line, comprising removing a length of a mooring line, leaving a first section of mooring line and a second section of mooring line; and inserting a compressive element according to the first aspect into the mooring line by attaching a first end of the compressive element to the first section of the mooring line and attaching a second end of the compressive element to the second section of the mooring line. All of the optional features disclosed herein with reference to the first and second aspects of the present invention apply likewise to the present method.

The floating structure may comprise a floating platform for a floating offshore wind turbine, for example. The floating platform may be any suitable and desired type of floating platform (e.g. for a floating offshore wind turbine), such as a semi-submersible platform, a spar platform, a barge platform or a tension leg platform. The type of platform may dictate the response that is desired from the mooring system and thus the mooring component. For example, a different response may be necessary depending on the depth of the water in which the mooring component is to be used, or depending on the type of platform e.g. whether the mooring system is required to provide stability.

The mooring component preferably comprises an attachment interface at one or both (e.g. each) end of the mooring component. The attachment interface is preferably designed and optimised for connecting the mooring component to other components in a mooring system, for example to tether lines and anchors. It is preferably a pad-eye or h-link type connector to allow for attachment to the rest of the mooring system with a shackle or pin. In one set of embodiments the compressive element is connected between the attachment interfaces at each end of the compressive element. The attachment interface is preferably non-elastic. The attachment interface is preferably arranged to transmit the tensile stress experienced by the mooring component (e.g. owing to the thrust on the mooring system) to the compressive element of the mooring component.

In one embodiment the mooring component comprises a first inner plate connected to the first or second annular portion of one of the plurality of shells (i.e. at one end of the compressive element), a second inner plate connected to the first or second annular portion of another of the plurality of shells (i.e. at the other end of the compressive element), a first outer plate adjacent to the first inner plate for connecting to a first portion of a mooring line, a second outer plate adjacent to the second inner plate for connecting to a second portion of a mooring line, a first connecting member connected to the first inner plate and the second outer plate (and, e.g., that extends through the second inner plate), and a second connecting member connected to the second inner plate and the first outer plate (and, e.g., that extends through the first inner plate).

This embodiment provides one example of how the compressive element may be included in a mooring component and, for example, included in a mooring line or system as outlined in the second aspect of the present invention, in which tension in the mooring line compresses the compressive element, resulting in an overall increase in the length of the mooring line. In an alternative arrangement, the outer plates can be eliminated with the attachment interfaces attached directly to the ends of the connecting members which extend through the inner plates.

The first and second connecting members may be provided in any suitable and desired way. In one embodiment the first and second connecting members comprise first and second connecting rods. Preferably the first and second connecting members each comprises a bar, e.g. a hollow bar having a rectangular cross-section or a bar having an I-beam shape. This helps to provide an arrangement having a low weight which is still rigid and has a relatively low risk of twisting. Using an I-beam helps to provide a bar that may be easier to weld. Furthermore, with an I-beam, the quality of any welding that is necessary can be confirmed after welding. In a second embodiment the first and second connecting members comprise first and second ropes and/or chains (e.g. a stiff rope such as wire or aramid). While such connecting members do not provide stiffness or resistance to twisting, they do provide a lighter, lower cost mooring component which may be more suitable for some mooring systems.

The weight of the connecting members and plates that connect to the compressive element may be an important factor when they are provided in a mooring component, line or system.

This is because it is preferred that the weight of the mooring component in the water (e.g. including the compressive element, the plates and the connecting members) is substantially equivalent, or at least as close as is achievable, to the weight in the water of a conventional catenary mooring chain (or other mooring line), to which the mooring component may be attached. Providing a hollow bar (or I-beam), for the connecting members helps to achieve this.

It may be, in some embodiments, that the compressive element may be heavier than the length of chain that it replaces, since it may be desired to provide the same strength as the chain, even when the mooring component is extended and the compressive element is compressed (e.g. up to 50% of the uncompressed length).

In one embodiment the first and second connecting members are metal, preferably steel. This choice of material helps to provide a structure that is rigid and low weight, and connecting members that are low cost and sufficiently strong. Furthermore, in at least preferred embodiments, the connecting members have a reduced risk of twisting, e.g. owing to the cross-sectional shape of the first and second connecting members.

In one embodiment one or more (e.g. all of) the first inner plate, the second inner plate, the first outer plate and the second outer plate comprise a flat ring. This helps to provide a plate capable of attaching to a number of connecting members as required, and withstanding the necessary forces, while reducing the weight of these components.

In at least some embodiments (e.g. when the mooring component is part of a mooring system), the mooring component is arranged to be placed close to the surface of the water. This helps to reduce stress on the rest of the mooring system. It also helps to ensure that wave or tidal motion causes only the mooring component (and not the entire mooring system) to stretch.

Features of any aspect or embodiment described herein may, wherever appropriate, be applied to any other aspect or embodiment described herein. Where reference is made to different embodiments or sets of embodiments, it should be understood that these are not necessarily distinct but may overlap.

Certain preferred embodiments of the invention will now be described, by way of example only, with reference to the accompanying drawings, in which:

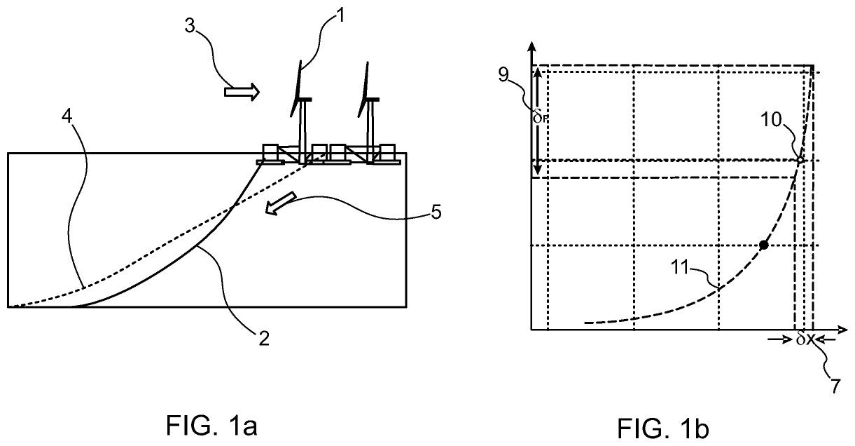

FIG. 1a shows a set of floating offshore wind turbines, moored using a mooring;

FIG. 1b shows the stress-strain response produced by the mooring system shown in FIG. 1a;

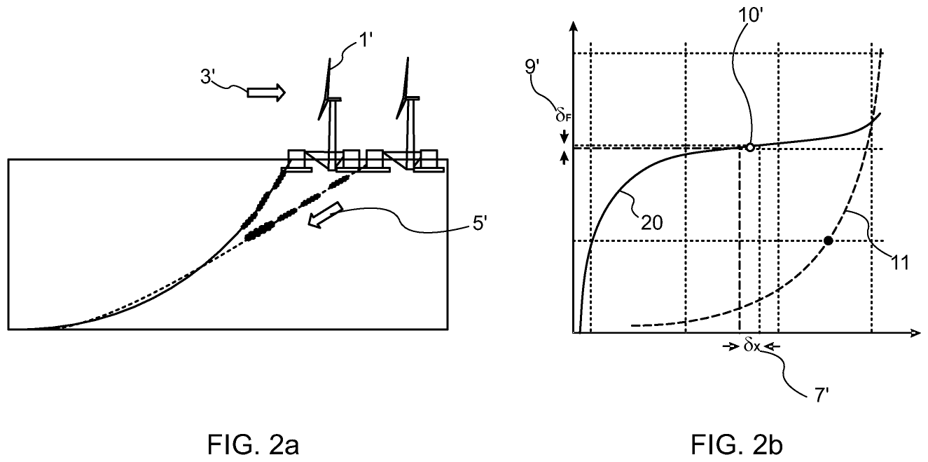

FIG. 2a shows a set of floating offshore wind turbines, moored using a mooring line according to an embodiment of the present invention;

FIG. 2b shows the stress-strain response produced by the mooring system shown in FIG. 2a;

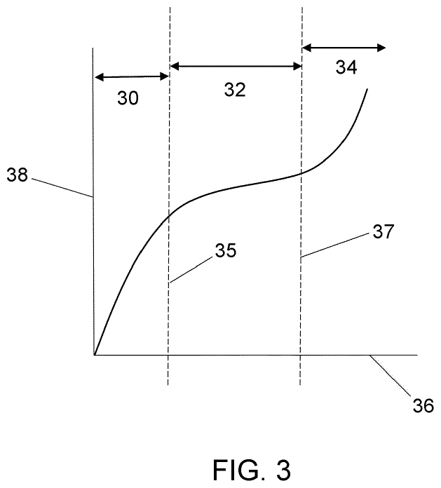

FIG. 3 shows an example of a desirable stress-strain response for a mooring system;

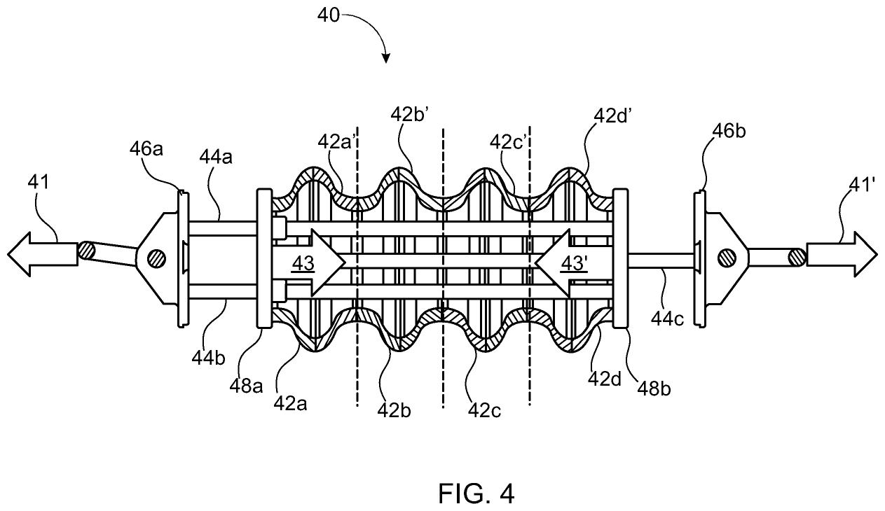

FIG. 4 shows a cross-sectional view of an elastomeric compressive element according to an embodiment of the present invention;

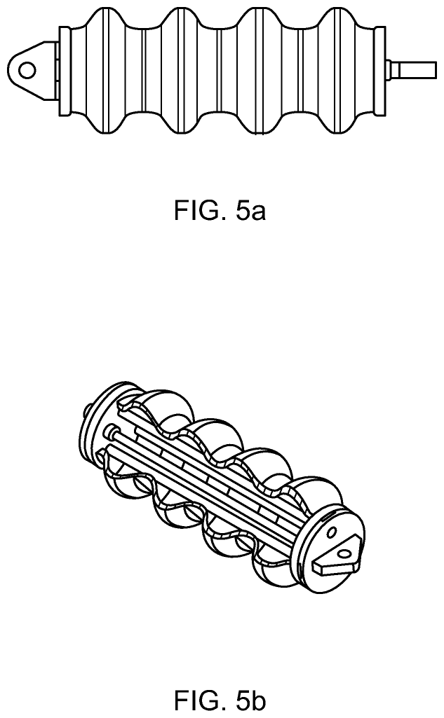

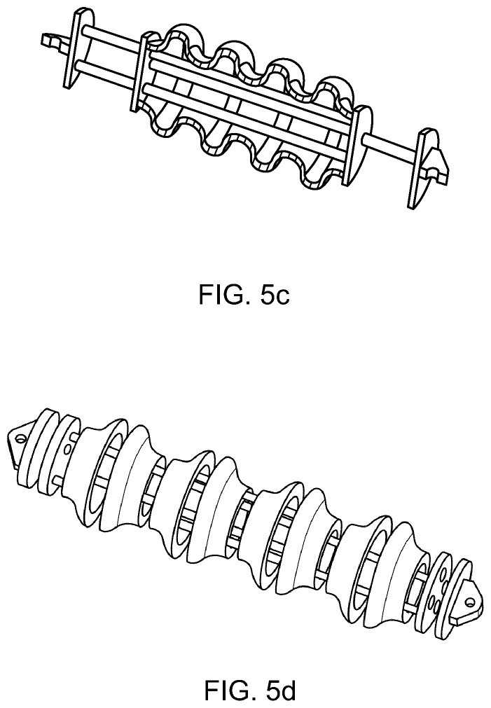

FIG. 5a shows the external appearance of the elastomeric compressive element shown in FIG. 4;

FIG. 5b shows a cutaway perspective view of the elastomeric compressive element shown in FIG. 4;

FIG. 5c shows a cross-sectional view of the elastomeric compressive element shown in FIG. 4;

FIG. 5d shows an exploded perspective view of the elastomeric compressive element shown in FIG. 4;

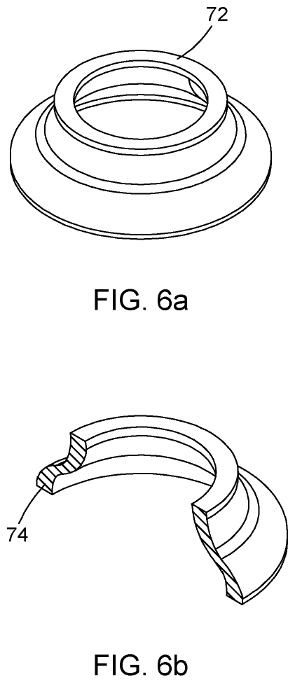

FIG. 6a shows a perspective view of a single shell of the elastomeric compressive element shown in FIGS. 5a to 5d;

FIG. 6b shows a cutaway perspective view of the single shell shown in FIG. 6a;

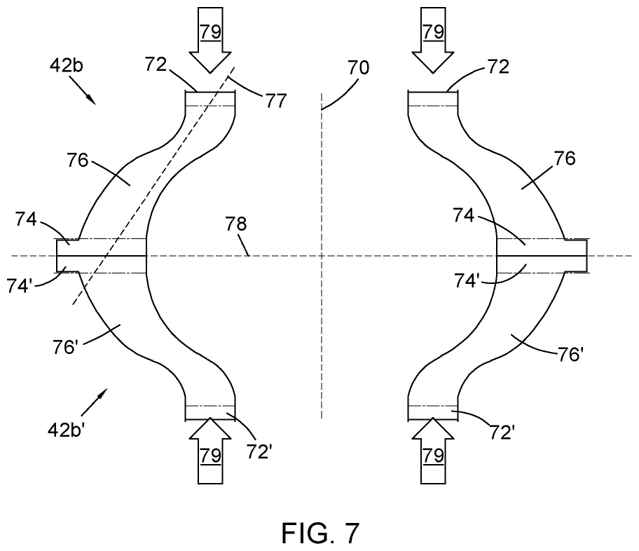

FIG. 7 shows an exemplary cross-sectional profile of two adjacent shells of an elastomeric compressive element;

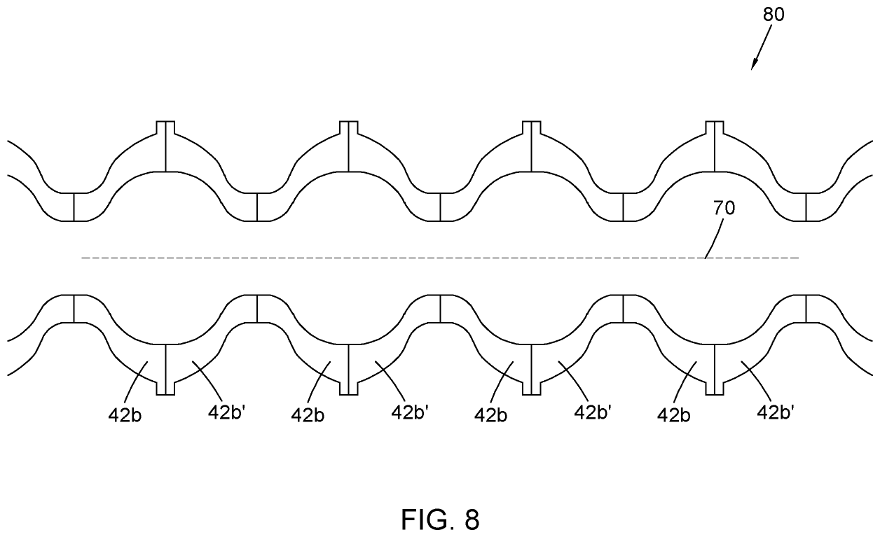

FIG. 8 shows a cross-sectional profile of a series of pairs of shells, as shown in FIG. 7, joined together to form a bellowed spring;

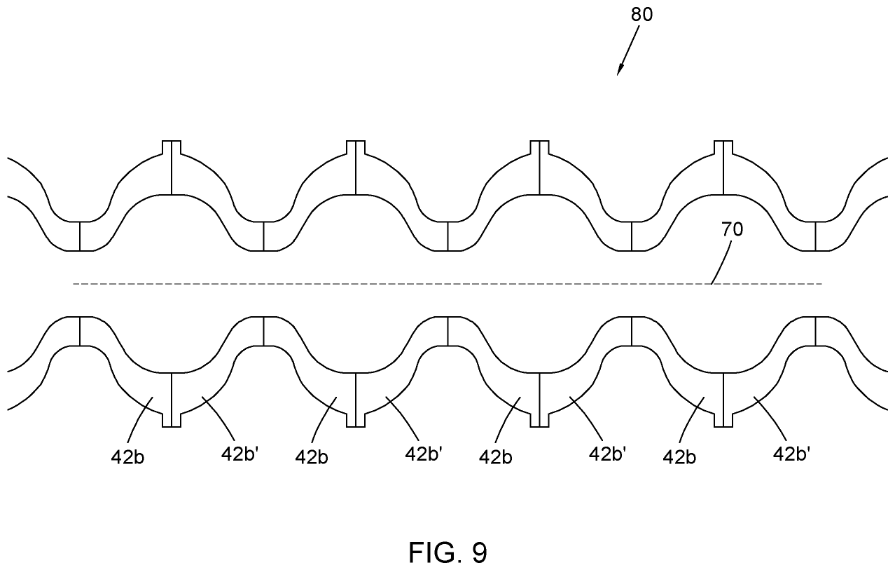

FIG. 9 shows the spring of FIG. 8 compressed to approximately the start of the second compression stage;

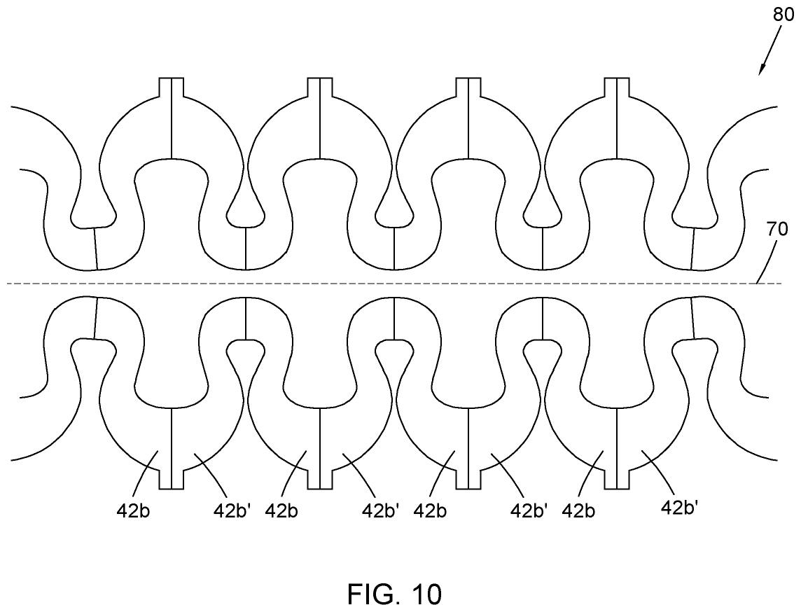

FIG. 10 shows the spring of FIG. 8 compressed to approximately the end of the second compression stage;

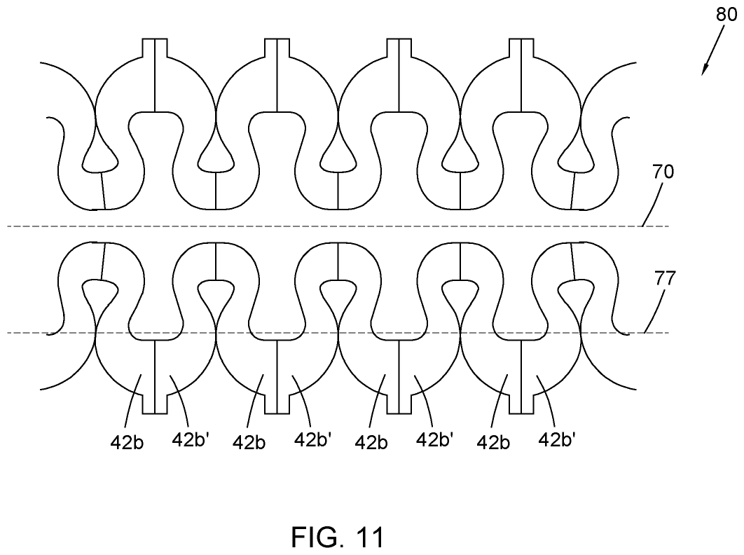

FIG. 11 shows the spring of FIG. 8 compressed to a point within the third compression stage;

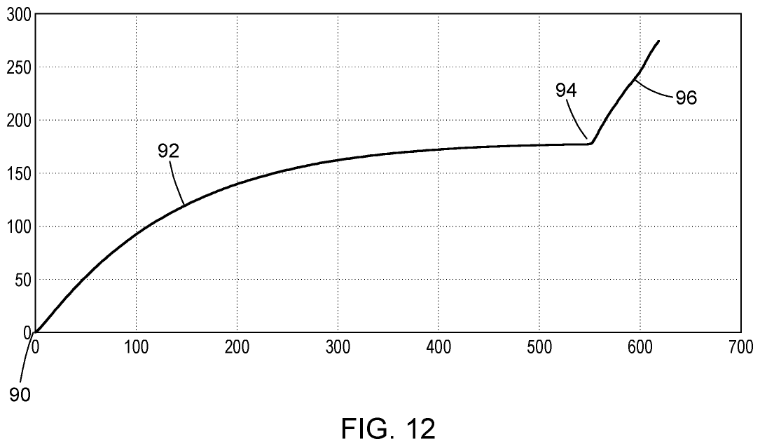

FIG. 12 is a graph showing the force response of the bellowed spring of FIGS. 8-11;

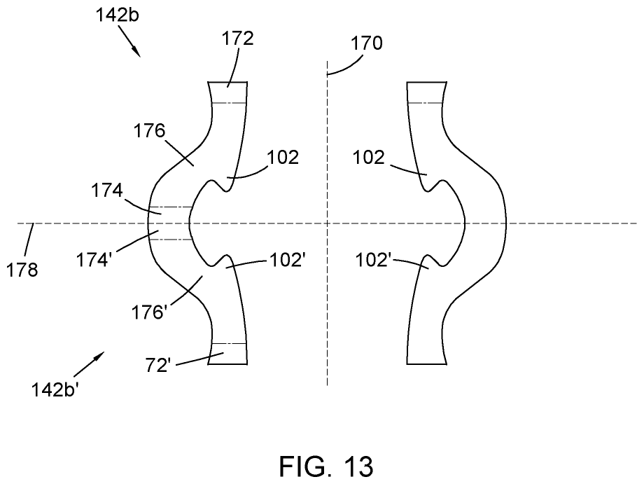

FIG. 13 shows another exemplary cross-sectional profile of two adjacent shells of an elastomeric compressive element;

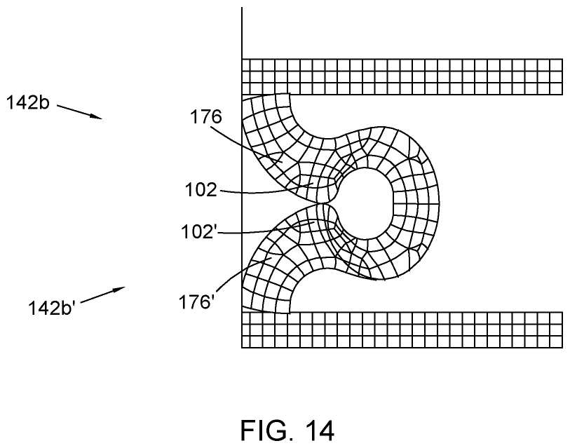

FIG. 14 is a cross-sectional profile of the shells of FIG. 13, when the adjacent shoulder portions have been brought into contact;

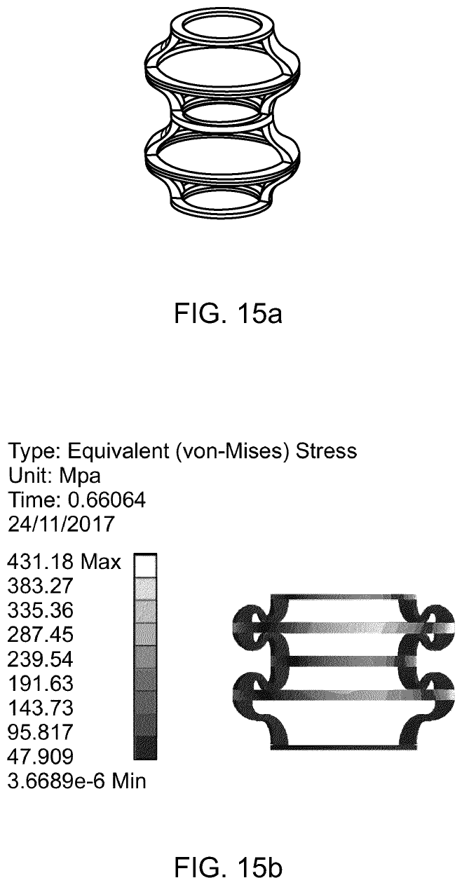

FIG. 15a shows an example of an elastomeric compressive element in which the central section comprises a number of profile sections; and

FIG. 15b shows the elastomeric compressive element of FIG. 15a under a compressive force.

Floating marine structures, such as floating offshore wind turbines, generally require a mooring system connected between the sea bed and the floating marine structure to keep the structure in place. Embodiments of a mooring component, for use in such a mooring system, will now be described.

FIG. 1a shows a floating offshore wind turbine 1, moored using a conventional catenary mooring system 2. The floating offshore wind turbine 1 is shown in two different positions, representing the position before and after the wind thrust is applied. A catenary mooring system comprises a length of chain, arranged so that one end is laying along the sea floor, whilst the other end is attached to the object that is moored. The horizontal arrow 3 represents the force acting on the mooring system as a result of wind causing action of the turbines 1.

This force 3 pushes the turbine 1 away from the direction of the wind. The initial tension in the mooring line is not sufficient to resist this motion and so the platform moves. As it moves more catenary chain 2 is lifted from the seabed increasing the tension in the mooring line, until an equilibrium position is reached where the horizontal component of the tension 5 in the mooring line balances the additional thrust due to the wind, shown by the dotted line 4.

FIG. 1b shows the stress strain response curve 11 produced by the catenary mooring system 2 of FIG. 1a. The x-axis 6 represents the distance X, in arbitrary units, that the turbine has been displaced from its ‘neutral’ position. This is the position in which the catenary mooring system 2 holds the turbine 1 when there is no thrust acting on the system due to wind, i.e. the position of the wind turbine 1 when the catenary chain is in position 2. The y-axis 8 represents the tension, in arbitrary units, present in the chain of the catenary mooring system. The additional wind thrust moves the platform to a new position 10, where the stiffness response of the mooring system (the additional tension required to move the platform) is much higher than in the original ‘neutral’ position.

It can be seen from this graph that, at large displacements from the ‘neutral’ position, a small amount of wave induced motion 7 results in a very large change 9 in tension experienced by the mooring system. This increases the size that the mooring components need to be so as not to break under the maximum tension. At these large displacements, for example at a point 10, the system is said to have high stiffness. This stress-strain response is undesirable as in high sea states the waves can induce large changes in the displacement X of the turbines 1. This can cause huge tension peaks to occur in the mooring system, which in turn induces fatigue in the system and raises the likelihood of failure of the mooring line.

FIG. 2a shows a mooring system containing a mooring component having multiple elastomeric compressive elements, in accordance with an embodiment of the present invention.

In this example the elastic compressive elements are connected along the same length of mooring line, i.e. “in series”. The turbine 1′ is once again subject to the wind force 3′, moving the platform away from the direction of the wind until the horizontal component of the tension 5′ matches the wind thrust. FIG. 2b is a stress-strain response graph of the mooring component.

The graph shows the response curve 20 provided by the mooring system shown in FIG. 2a containing the mooring component in comparison to the response curve 11 of the conventional catenary mooring system (as shown in FIG. 1a).

Certain features of the compressive elements are designed to give a stress-strain response as described herein, and the thrusts at which each stage of the stress-strain response begins are selected by adjusting these features, so as to be suitable for a particular mooring environment.

In this case, the compressive elements are designed such that the thrust load, which moves the turbine to the position shown on the right of FIG. 2a, in which the thrust load is balanced by the horizontal component of the tension in the mooring line 5′, compresses each compressive element to within the second stage of compression. As seen in the graph of FIG. 2b, at this position 10′, which is within stage 2 of compression (the operational range of the component), the stress-strain response curve flattens out such that a change of the platform displacement 7′, for example due to a wave, only results in a small change in the tension 9′.

As shown in FIG. 3, an example of a stress-strain response (as also shown in FIG. 2b), which is more desirable than the conventional response shown in FIG. 1b, can be broken down approximately into three separate stages. The x-axis 36 in FIG. 3 shows stress, in arbitrary units, whilst the y-axis 38 represents strain, again in arbitrary units. This stress-strain response may be scaled to a particular value depending on the system in which it is intended to be incorporated.

In the first stage 30, up to a first value 35 of the stress, a mooring system having the response of FIGS. 2b and 3 exhibits a high stiffness. This high stiffness causes a small extension of the mooring system to result in a large increase in thrust. In some examples, the mooring system will not operate within this range, in use, as pre-tension and thrust load acting on the mooring system when in use will pre-compress the compressive element such that the system operates in the second stage of compression 32. Should for some reason the thrust load not be present and the pre-tension not be high enough so that the experienced tensions are within this second stage, the high stiffness of the component in the first stage results in the overall mooring system behaving as a traditional mooring system within this range.

In the second stage 32, above the first value 35 of the stress and up to a second value 37 of the stress, the mooring system has a gently sloping response curve, thus having a lower stiffness than in the first stage 30. This is the operational range of the component and the first value is chosen based on the turbine thrust and pre-tension as described above, while the second value 37 is chosen based on the ultimate limit state. In this second stage 32, a change in platform position away from the anchor (e.g. due to a wave) will result in a small but appreciable increase in tension on the mooring line, and vice versa. If the response in the second stage 32 of the stress-strain response curve is too flat, then a small increase in the wind thrust applied to the platform will result in a large increase in the extension of the mooring line, leaving very little extension available for managing wave motions.

In the third stage 34 of the stress-strain response curve, above the second value 37 of the stress, the extension of the mooring line is large. In the third stage 34, the mooring exhibits a high stiffness once again, such that a small extension of the mooring system results in a large increase in thrust. This is designed to ensure that the platform is kept within a target surge (distance from the ‘neutral’ position) and to ensure that the component can manage unexpected loads.

The Applicant has designed a polymer mooring component, in accordance with at least preferred embodiments of the present invention, with particular design features that aim to implement each of the stages 30, 32, and 34 of the stress-strain curve. These various features will be described in greater detail below.

The stress-strain curve, as achieved by the polymer mooring component, in accordance with at least preferred embodiments of the present invention, provides a number of benefits to a mooring system. The risk of failures during shock loading is reduced, which reduces repair and insurance costs; smaller components can be used to deliver the same capability of a much larger mooring chain, thereby reducing the component cost and the deployment cost; and also reducing the operational costs since fewer repairs to the infrastructure are required.

FIG. 4 shows a cross-sectional view of an elastomeric compressive element 40 according to an embodiment of the present invention. FIG. 5a shows the external appearance of the elastomeric compressive element 40 shown in FIG. 4. FIG. 5b shows a cutaway perspective view of the elastomeric compressive element 40 shown in FIG. 4. This cutaway view shows a section of the outer surface cut away to show the inner structure. FIG. 5c shows a cross-sectional view of the elastomeric compressive element 40 shown in FIG. 4. This cross-sectional view shows the front half of the element cutaway. FIG. 5d shows an exploded perspective view of the elastomeric compressive element shown in FIG. 4, where the polymer spring is assembled from eight identical individual polymer shells.

The elastomeric compressive element 40 in the embodiment shown in FIGS. 4, 5a, 5b, 5c and 5d comprises four bellows, or convolutes, consisting of eight shells in total, arranged end-to-end along a single axis. Through the centre of the bellows there are arranged four steel rods, parallel to the central axis along which the bellows are arranged. As one of the steel rods is in front of the other from the perspective of FIG. 4, only three steel rods 44a, 44b, 44c can be seen. Two of the steel rods 44a, 44b are each attached at a first end to a first outer plate 46a and are attached at a second end to a second inner plate 48b, which is attached to the end of the row of bellows. The other two steel rods 44c are similarly attached between a second outer plate 46b and a first inner plate 48a. The steel rods 44a, 44b, 44c each comprise an I-beam.

The elastomeric compressive element 40 can be incorporated into a mooring line by attaching the outside of each of the outer plates 46a, 46b to sections of the mooring line. The end of the mooring line sections can then be in contact with a sea bed, e.g. via an anchor, whilst the end of the other section of the mooring line can be connected to a floating body which is to be moored, for example a floating offshore wind turbine.

Owing to the arrangement of the inner and outer plates 46a, 46b, 48a, 48b, as the tension in the line increases, each of the first and second outer plates 46a, 46b is acted on by a tensile force, in the direction along the axis of the bellows and away from the bellows. These tensile forces are shown by the arrows 41, 41′. As a result of these tensile forces, the inner end plates 48a, 48b each apply an inwards compressive force onto the bellows, as shown by the force arrows 43, 43′.

Each of the bellows comprises two halves, also known as “shells” 42a, 42a′, 42b, 42b′, 42c, 42c′, 42d, 42d′. Each of these shells is approximately identical. The shells can be joined together by a number of possible methods, including welding. Alternatively, the elastomeric compressive element, including the bellowed shape, can be formed as a single piece. FIG. 5d shows an exploded perspective view of the elastomeric compressive element 40 as shown in FIG. 4. The elastomeric compressive element 40 is shown in FIG. 5d in a “blown-up” format, so that each shell is shown separated and the steel rods can be seen through the gaps between adjacent shells.

FIG. 6a shows a perspective view of a single shell 42a of the elastomeric compressive element 40 shown in FIGS. 5a to 5d, during the second stage of compression (i.e. compressed to a stress value higher than 35 in FIG. 3). FIG. 6b shows a cutaway perspective view of the single shell 42a shown in FIG. 6a. The cutaway perspective view shown in FIG. 6b shows the profile of the thickness of the shell material.

The Applicant has appreciated that various features of the profile of the shell contribute to the three stages 30, 32 and 34 as shown in FIG. 3, as will be described below. The desired stress-strain response can be achieved by adjusting a large variety of parameters of the shells or compressive element, and the examples given below are intended to be exemplary but not limiting.

FIG. 7 shows a cross-sectional profile of two adjacent shells 42b, 42b′ of an elastomeric compressive element, according to an embodiment of the present invention, in an uncompressed state. In order to assist in understanding, the dashed line 78 shows the separation between the upper shell 42b and the lower shell 42b′, as shown in FIG. 7. This distinction may be merely conceptual, since a series of such shells i.e. a compressive element, may be integrally formed.

Each shell 42b, 42b′ comprises a first, outer, annular portion 74, 74′ and a second, inner, annular portion 72, 72′, with a central section 76, 76′ extending between them. The shells 42b, 42b′ are formed by rotating the shell profile, as shown in FIG. 7, through 360 degrees around a central axis 70, giving a two-sided symmetric profile shape as shown in FIG. 7.

One or both of the first, outer, annular portion 74, 74′ and the second, inner, annular portion 72, 72′ may be strengthened. For example, these annular portions 72, 72′, 74, 74′ may be thicker than the central section 76, 76′ of the shell and/or they could be made of a higher grade or stiffer polymer material than the central section 76 of the shell.

FIG. 8 shows a series of such shells 42b, 42b′, joined together to form the bellows of the elastomeric element of the mooring component. The bellows 80 (also referred to as convolutes) are in an uncompressed state in FIG. 8 i.e. 0% compression, when no load is applied to the bellows 80. The stages of compression of the bellows 80 will be described below with reference to FIGS. 9, 10 and 11, and the response curve of FIG. 12.

FIG. 12 is a graph representing the force response of bellows 80 to compression. The x-axis shows displacement in units of mm, and the y-axis shows the resistance force produced by the bellows 80, in units of kilo-Newtons (kN). FIG. 8 represents the compression at point 90, i.e. 0% compression of the bellows 80.

FIG. 9 shows the cross-sectional profile of the two adjacent shells 42b, 42b′, in a partially compressed state, i.e. at point 92 on the graph of FIG. 12. The partially compressed state of the shells 42b, 42b′ corresponds approximately to the first stress value 35 shown in FIG. 3, i.e. the start of the second phase of compression. In these exemplary bellows 80, this occurs at a compression of approximately 10% (of the uncompressed length shown in FIG. 8). It is clear from comparison of FIGS. 8 and 9 that the shells 42b, 42b′ of the bellows 80 substantially maintain their shape during the first phase of compression (i.e. compression from the arrangement of FIG. 8 to the arrangement of FIG. 9), and thus upon initial compression, the compressive element 80 comprising shells 42, 42′ with a cross-sectional profile as shown in FIG. 7 will deform very little. This may for example be achieved through selection of a suitable material stiffness.

When the shells 42b, 42b′ are joined together to form the bellows of the elastomeric compressive element of the mooring component, the relative distance of the annular portions 72, 72′, 74, 74′ (where the shells 42b, 42b′ join) from the central axis 70 defines a load pathway 77. It is along this pathway 77 (for a particular shell) that the compressive force 79 applied to the elastomeric compressive element is transmitted. This occurs because a load pathway 77 as shown in FIG. 7 forms a relatively small angle with the central axis 70, causing the compressive element to have a relatively high stiffness in the configuration shown in FIG. 7.

This stiff response can be seen in the steep gradient of the stress-strain response curve shown in FIG. 3 (and FIG. 12).

As the compressive force on the compressive element increases, the shells 42b, 42b′ flex (about the first, outer, annular portion 74, 74′ and the second, inner, annular portion 72, 72′). As the compression of the compressive element increases, the angle of the load pathway 77 with the central axis 70 increases. Approaching and through the change from the first to second stages 30, 32 of stress-strain response curve (as shown in FIG. 3), the gradient of the stress-strain response curve lessens as the compressive element becomes less stiff. This is also seen in the particular response curve graph of FIG. 12. This lower gradient of the stress-strain response curve continues through the second stage 32 until the second stress value 37 is reached, as described below with reference to FIG. 10. FIG. 10 shows the cross-sectional profile of the two adjacent shells 42b, 42b′, in a compressed state, corresponding approximately to point 94 in FIG. 12. Thus FIG. 10 shows the state of compression of the bellows 80 approximately at the end of the second phase 32 of compression. It can be seen in FIG. 10 that some of the adjacent shells 42b, 42b′ are just starting to come into contact at the adjacent outer sides of their respective central sections 76, 76′. This results in a sharp increase in the stiffness of the bellows 80, and therefore produces the large increase in gradient seen after the point 94 on the graph of FIG. 12. Specifically, the contacting of the outer surfaces of the central sections 76, 76′ of adjacent shells 42b, 42b′ changes the load pathway 77 to reduce the angle between the load pathway 77 and the central axis 70. This produces the increased stiffness seen in the graph of FIG. 12.

Further compression beyond this compression value further increases contact between adjacent shells 42b, 42b′, as shown in FIG. 11. FIG. 11 shows the compression of the bellows 80 at approximately the value 98 shown on the graph of FIG. 12. It can be seen that this contact gives a load pathway 77 approximately parallel to the central axis 70 resulting in the high stiffness. This high stiffness at large compression ensures that the bellows are able to withstand thrust values which occur in the Ultimate Limit State (ULS) of the mooring system.

Additionally, or alternatively, some or all of the features of the response curve achieved herein may be achieved by including one or more shoulder portions on the shell. A shoulder portion is essentially a more pronounced thickening of a portion of the shell, extending in a direction away from the shell, as described above.

One example of such a shell is shown in FIG. 13.

FIG. 13 shows a cross-sectional profile of two adjacent shells 142b, 142b′ of an elastomeric compressive element, according to another embodiment of the present invention. In order to assist in understanding, the dashed line 178 shows the separation between the upper shell 142b and the lower shell 142b′, as shown in FIG. 13. This distinction may be merely conceptual, since a series of such shells i.e. a compressive element, may be integrally formed.

Each shell 142b, 142b′ comprises a first, outer, annular portion 174, 174′ and a second, inner, annular portion 172, 172′, with a central section 176, 176′ extending between them. The shells 142b, 142b′ are formed by rotating the shell profile, as shown in FIG. 13, through 360 degrees around a central axis 170, giving a two-sided symmetric profile shape as shown in FIG. 13.

Each central section 176, 176′ comprises a respective inner shoulder portion 102, 102′ that projects from the inner surface of the central section 176, 176′ towards the first, outer, annular portion 74, 74′. Contact between adjacent shoulder portions 102, 102′ may give rise to the third phase of the response curve, in a similar manner to that described above. Contact of the adjacent shoulders 102, 102′ is illustrated in FIG. 14. Alternatively, the shoulder portions 102, 102′ may be arranged to contact at any desired point during the stress-strain response curve, to assist in providing the desired response curve. Multiple such shoulders may be provided on both the inner and/or the outer surfaces of the shells 42b, 42b′, both in the annular portions and in the central section.

As described, the shells 42b, 42b′, 142b, 142b′ are formed by rotating the shell profile, as shown through 360 degrees around the central axis 70, 170, thus forming a solid of revolution.

Alternatively, a shell may comprise a plurality of profile sections, each consisting of rotations of the profile shown about the axis 70 through only certain limited angles, of less than 180 degrees. In this latter case, multiple profile sections are then joined to the first, outer, annular portion 74, 74′, 174, 174′ and the second, inner, annular portion 72, 72′, 172, 172′. Each of the annular portions 72, 72′, 74, 74′ extend (and are thus continuous) through 360 degrees. One such example is shown in FIGS. 15a and 15b.

FIG. 15a shows an example of an elastomeric compressive element in which the central section comprises a number of profile sections, which are joined at the top and bottom circumferences. The Applicant has appreciated that these portions must be at least partial revolutions of the shell profile described already through at least a minimum angle, in order to give the desired non-linear response curve, otherwise the response profile of the shell will be similar to that of a beam, and not show the desired non-linear response. FIG. 15b shows the deformation of the elastomeric compressive element of FIG. 8a when acted on by a compressive force.

It will be appreciated by those skilled in the art that the invention has been illustrated by describing one or more specific embodiments thereof, but is not limited to these embodiments; many variations and modifications are possible, within the scope of the accompanying claims.

1. A compressive element for a mooring component, the compressive element comprising a plurality of shells, wherein each of the plurality of shells comprises a first annular portion, a second annular portion and a central section;
wherein the first annular portion and the second annular portion each lie in a plane that is substantially perpendicular to a central axis of the compressive element, wherein the first annular portion has a maximum dimension in a direction substantially perpendicular to the central axis that is greater than a maximum dimension of the second annular portion in a direction substantially perpendicular to the central axis, and wherein the central section connects and extends between the first annular portion and the second annular portion;
wherein the plurality of shells are arranged along the central axis such that the first annular portion of one of the plurality of shells is joined to the first annular portion of an adjacent shell of the plurality of shells or such that the second annular portion of one of the plurality of shells is joined to the second annular portion of an adjacent shell of the plurality of shells;
wherein the compressive element is arranged such that when a compressive stress is applied to the compressive element substantially in the direction of the central axis, the compressive element is compressed; and
wherein the compressive element is arranged such that when the compressive stress applied to the compressive element causes the compressive element to be compressed by a particular fraction of an uncompressed length of the compressive element, the central section of one of the plurality of shells contacts the central section of an adjacent shell of the plurality of shells.

2. The compressive element of claim 1, wherein the compressive element is arranged such that the annular portions of the compressive element have a hoop stress that substantially resists the component of the compressive stress acting in tension on the first annular portion and in compression on the second annular portion.

3. The compressive element of claim 1, wherein a thickness of the first and/or second annular portions is greater than a minimum thickness of the central section.

4. The compressive element of claim 1, wherein a length of the central section is greater than a height of the first and/or second annular portions.

5. The compressive element of claim 1, wherein a thickness of the first and/or second annular portions is greater than a height of the first and/or second annular portions, respectively.

6. The compressive element of claim 1, wherein the maximum dimension of the first annular portion is greater than 40% larger than the maximum dimension of the second annular portion.

7. The compressive element of claim 1, wherein the first annular portion and/or the second annular portion is configured to deform when the compressive force exceeds a threshold that causes the compressive element to be compressed by more than the particular fraction.

8. The compressive element of claim 1, wherein the central section is configured to deform when the compressive stress exceeds a threshold that causes the compressive element to be compressed by more than the particular fraction.

9. The compressive element of claim 1, wherein the central section has a non-uniform thickness along its length.

10. The compressive element of claim 1, wherein the central section has a non-uniform shape, such that a thickness of the central section parallel to the central axis varies along the central axis.

11. The compressive element of claim 1, wherein the compressive element is arranged such that the compressive stress applied to the compressive element up to a first stress value of the compressive stress compresses the compressive element in a first stage of compression by up a first fraction of an uncompressed length of the compressive element,
wherein the compressive element is arranged such that the compressive stress applied to the compressive element above a first stress value of the compressive stress and up to a second stress value of the compressive stress further compresses the compressive element in a second stage of compression by greater than the first fraction of the uncompressed length of the compressive element and up to a second fraction of the uncompressed length of the compressive element, and
wherein the second fraction of the uncompressed length of the compressive element is less than or approximately equal to the particular fraction of the uncompressed length of the compressive element at which the central sections of adjacent shells are arranged to contact each other.

12. The compressive element of claim 11, wherein the compressive element exhibits a non-plastic response up to the second stress value.

13. The compressive element of claim 1, wherein the central section of each of the plurality of shells comprises a shoulder portion projecting from an inner surface or an outer surface of the central section, wherein shoulder portions of adjacent shells are arranged to contact each other under compression.

14. The compressive element of claim 13, wherein the first shoulder portion projects from the inner surface of the central section.

15. (canceled)

16. (canceled)

17. The compressive element of claim 13, wherein the first shoulder portion is shaped so that, when the compressive stress applied to the compressive element causes the compressive element to be compressed by the particular fraction of the uncompressed length of the compressive element, the first shoulder portion projects further towards the adjacent shell than any other part of the central section.

18. The compressive element of claim 1, wherein the first annular portion of one of the plurality of shells is welded or glued to the first annular portion of an adjacent shell of the plurality of shells and/or such the second annular portion of one of the plurality of shells is welded or glued to the second annular portion of an adjacent shell of the plurality of shells.

19. (canceled)

20. The compressive element of claim 1, wherein the compressive element is formed from at least one polymer material.

21. The compressive element of claim 1, wherein the compressive element is formed integrally as a single piece.

22. The compressive element of claim 1, further comprising a first inner plate, connected to one end of the compressive element, a second inner plate connected to the other end of the compressive element, a first outer plate adjacent to the first inner plate for connecting to a first portion of a mooring line, a second outer plate adjacent to the second inner plate for connecting to a second portion of a mooring line, a first connecting member connected to the first inner plate and the second outer plate, and a second connecting member connected to the second inner plate and the first outer plate.

23. (canceled)

24. A mooring system comprising:
a mooring line, and
the compressive element of claim 1,
wherein the compressive element is arranged between a first section of the mooring line and a second section of the mooring line such that tensile stress applied to the mooring line, which compresses the compressive element, causes the overall length of the mooring system to increase.

25. (canceled)
